(19) United States
(12) Patent Application Publication
(10) Pub. No.: US 2006/0117268 A1
(43) Pub. Date: Jun. 1, 2006

(54) System and method for graphical element selection for region of interest compression

(76) Inventors: Micheal Talley, Boise, ID (US); Terry Fritz, Boise, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/999,728

(22) Filed: Nov. 30, 2004

(51) Int. Cl. G06F 17/00; G06F 9/00

(52) U.S. Cl. 715/769; 715/823

(57) ABSTRACT

Systems and methods for graphical element selection with region of interest compression. The method includes determining a region of interest on a page and identifying a graphical element on the page. The method further includes associating the identified graphical element with the region of interest based on the position of the graphical element on the page relative to the region of interest and then generating a graphical element tag based on the association, wherein the graphical element tag is included in a region of interest enhanced page description. Finally the method includes compressing the page based on the region of interest enhanced page description using a regionally variable compression algorithm. In other configurations, methods of the invention are implemented by computer executable code stored to a computer readable media.

### BACKGROUND

Word processing and graphical element editor programs are frequently utilized with a computer within a network to provide various document creation and editing features to a user. Imaging devices, such as printers, are utilized to render and print images created with graphical element editor programs to tangible media such as paper stock. A printer typically uses a compression engine in order to process images prior to printing. Compression engines reduce the amount of data from an image file that is sent to a rendering engine or a page buffer memory. Present standardized compression schemes, such as, for example, the JPEG standard (Joint Photographic/Picture Expert Group, ISO/IEC IS 10918-1|ITU-T Recommendation T.81) and the JPEG 2000 standard (ISO/IEC 15444 and ITU-T T.8000) specify various types of lossy and lossless data compression algorithms. Specifically, JPEG 2000 allows specified regions of a page to be compressed using a lower loss rate algorithm. A region of a page selected for compression is typically known as a “region of interest.” A “region of interest” on a page typically contains one or more graphical elements, such as text blocks or images. However, a text block usually requires much less imaging resolution than a JPEG image, for example, in order to realize a quality printed image. Therefore a region of interest containing only text could employ a lower resolution compression algorithm without sacrificing printed image quality. Generally, imaging devices such as printers incorporate a page frame buffer memory into which a page is compressed prior to rendering and printing an image. Typically, when a page is too large to compress into the available buffer memory, lossy compression is applied over the entire page. It would be desirable therefore, to provide advancements to the art that overcome these and other disadvantages.

### SUMMARY

According to an embodiment of the present invention, a method is directed to graphical element selection for region of interest compression. The method includes determining a region of interest on a page and identifying a graphical element on the page. The method further includes associating the identified graphical element with the region of interest based on the position of the graphical element on the page relative to the region of interest, and then generating a graphical element tag based on the association. According to the method, the graphical element tag is included in a region of interest enhanced page description. Finally the method includes compressing the page based on the region of interest enhanced page description using a regionally variable compression algorithm.

According to another embodiment, a method is directed to selecting graphical elements on a page for variable region compression. The method includes identifying a region of interest on a page based on a graphical element type and selectively mapping one or more graphical elements on the page to the identified region of interest. The method further includes generating a page description that describes the region of interest portion of the page. According to the method, the page description relates the one or more selectively mapped graphical elements to the region of interest. The method also describes providing the page description to a compression engine. According to the method, the page description invokes high resolution compression for the region of interest portion of the page. Finally, the method provides for rendering the page based on the page description.

According to still another embodiment, a system for implementing graphical element selection for region of interest compression is described. The system includes imaging means, the imaging means including compression means, the compression means operable to provide variable resolution compression to selected regions of a page and computing means. The computing means includes user interface means, communication interface means, processing means, and computer readable memory means which are readable by the processing means. The computer readable memory means includes a graphical element editor program, a driver program and a series of computer executable steps configured to cause the processing means to execute steps. When executed by the processing means, the computer executable steps operate to determine a region of interest on the page and identify a graphical element on the page. The computer executable steps further operate when executed to associate the identified graphical element with the region of interest based on a position of the graphical element on the page relative to the region of interest and generate a graphical element tag based on the association, wherein the graphical element tag is included in a region of interest enhanced page description. Finally, the computer executable steps operate when executed to compress the page based on the region of interest enhanced page description using a regionally variable compression algorithm.

The foregoing, and other features and advantages of the invention, will become further apparent from the following detailed description of the presently preferred embodiments read in conjunction with the accompanying drawings.

### DESCRIPTION OF THE DRAWINGS

FIG. 1 is a block diagram of system for implementing graphical element selection for region of interest compression, illustrating an embodiment of the present invention.

FIG. 2 illustrates an exemplary page having graphical elements and a region of interest, in accordance with an embodiment of the present invention.

FIG. 3 is a flow diagram depicting a method, in accordance with an embodiment of the present invention.

FIG. 4 is a flow diagram depicting a method, in accordance with yet another embodiment of the present invention.

### DETAILED DESCRIPTION

Non-limiting embodiments of the present invention provide for methods and systems for selecting graphical elements on a page for variable region compression. According to an embodiment of the present invention, a system provides graphical element selection for region of interest compression.

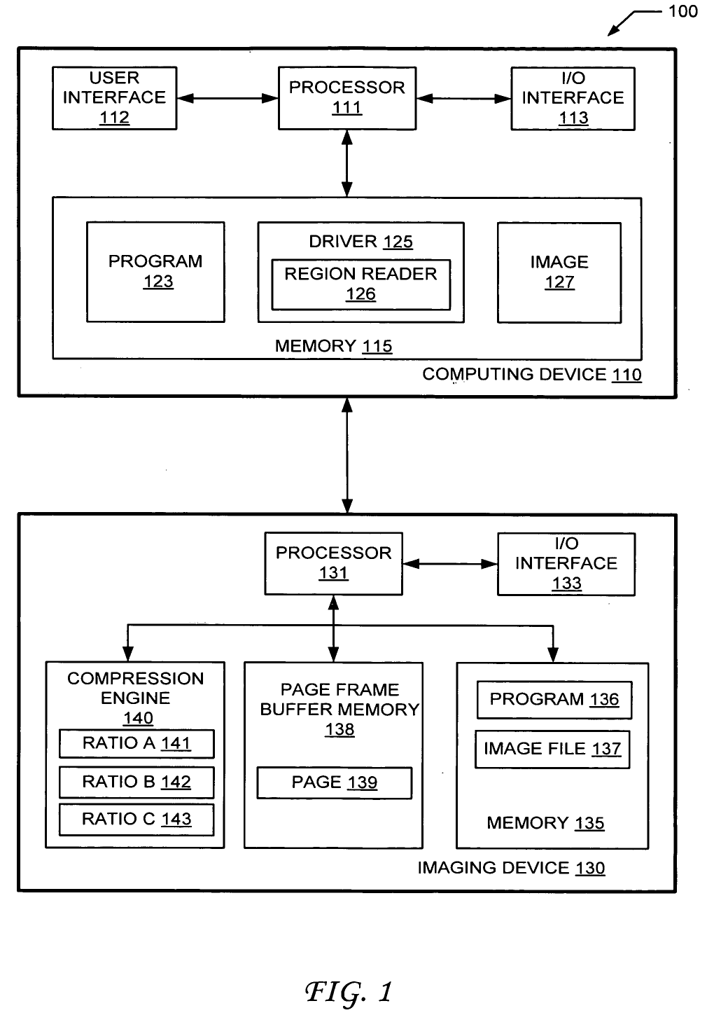

FIG. 1 is a block diagram of system for implementing graphical element selection for region of interest compression, in an embodiment of the present invention. FIG. 1 illustrates a system 100 configured to implement graphical element selection for region of interest compression. Exemplary devices of system 100, as shown in FIG. 1, include computing device 110 and imaging device 130. Each device of system 100 has a unique device identification and device address, such that the connected devices are enabled to communicate with one another and provide various distributed services.

FIG. 1 shows computing device 110 further comprising a processor 111, a user interface 112, an input/output interface 113, and a memory device 115. The memory device 115 is shown including a program 123, a driver 125 having a region reader 126, and an image file 127. Processor 111 is further shown enabled for bidirectional communication with user interface 112, input/output port 113, and memory device 115. In FIG. 1, computing device 110 is shown enabled for bidirectional communication with imaging device 130. In another embodiment (not shown) additional devices are connected to system 100 though communication interfaces, such as input/output interface 113.

Computing device 110 is any device configurable for providing an interface to various functions and services provided by computing device 110 and other devices of system 100. In an embodiment, computing device 110 is a personal computer (PC) that includes various capabilities provided by one or more programs 123 that may be loaded into memory 115 for execution. The skilled practitioner will recognize that in some implementations computing device 110 includes additional components not relevant to the present discussion.

Processor 111 of computing device 110 is any microprocessor, microcontroller, application-specific integrated circuit (ASIC), or combination of the recited components, configured to execute computer instructions. In an embodiment, processor 111 includes memory for caching data. Memory device 115 includes volatile and/or non-volatile computer readable memory, such as, for example, random access memory (RAM), flash memory and the like. In an embodiment, processor 111 is configured to execute instructions from one or more programs and services, such as program 123 and driver 125 stored in memory 115, and to manipulate digital data, such as image data 127.

Program 123 includes one or more computer executable instruction sets, such as device drivers and programs that perform various functions, such as, for example, controlling peripheral devices, providing capabilities to a user, and managing communications with other devices. In another embodiment, program 123 is a graphical element editor program that provides image editing services to generate, manipulate and select one or graphical elements on a page that can be used with region of interest compression. In yet another embodiment, program 123 is configured to generate a page description, in a page description language, that includes one or more layers describing elements and properties of a page. In still another embodiment, program 123 is configured for one or more functions such as, for example, determining a region of interest on a page, identifying a graphical element on the page, associating the identified graphical element with the region of interest based on the position of the graphical element on the page relative to the region of interest and generating a graphical element tag based on the association. In some implementations, a page description is generated in a language such as, for example, PostScript, printer control language (PCL) and portable document format (pdf). In one embodiment, program 123 is configured for mapping a graphical element on a page to a region of interest in a graphical element layer of a page description. In a further embodiment, program 123 is configured as a graphical element-type recognition system. Graphical elements include glyphs, vectors, and raster images such as, for example a text block, an image (e.g., tif, .bmp, etc.) borders, outlines, shading and any other page elements that compose a page. In order to keep track of what types of graphical elements compose a page, all graphical elements are grouped into one of several “graphical element types.” Each graphical element is characterized by categorical properties, and graphical elements with similar properties are of a similar graphical element-type, and can be identified based on one or more predetermined graphical element-type properties. In one embodiment, a “graphical element map” is a mapping of the types of graphical elements on a page that can be compressed differently based on the graphical elements that are deemed most important, either by a user or by a program. In another embodiment, the “graphical element map,” is a pixel-by-pixel representation of a page based on “graphical element types” that is rendered along with the page to improve page quality during printing. A “graphical element tag” marks a graphical element and, in some implementations, can describe graphical element properties within a structured language description of a page.

In one embodiment, program 123 is configured for automatic selection of regions of interest based on graphical element type.

Driver 125 includes one or more programs and/or instruction sets for controlling a hardware device. In one embodiment, driver 125 includes a region reader program 126 for identifying graphical elements within a defined spatial region of a page or page description language file. In another embodiment, driver 125, or a component of driver 125, is configured for identifying a region of interest on a page based on a graphical element-type.

In another embodiment, driver 125 is configured to perform one or more functions, such as for example, selectively mapping one or more graphical elements on a page to an identified region of interest. In yet another embodiment, driver 125 is configured to generate a page description that describes the region of interest portion of the page. In the present embodiment, the page description relates one or more selectively mapped graphical elements to the region of interest. In still another embodiment, the driver 125 provides the page description to a compression engine. In one embodiment, a graphical element map is a rendered representation of the final placement of graphical elements on a page.

User interface 112 is any arrangement of data-entry and display devices configured to display information to a user and to receive user input to computing device 110. In an embodiment, user interface 112 includes components such as, for example, a keyboard, a pointing device, and/or a visual display device suitable for displaying images and/or receiving user input from a user. In another embodiment, user interface 112 is configured to receive user instructions indicating a region-of-interest. In yet another embodiment, user interface 112 is configured to receive user instructions selecting one or more graphical elements on a page that define a region-of-interest.

Input/output interface 133 includes one or more communication interfaces configured to provide signal and data input and output to computing device 110. In an embodiment, input/output interface 113 includes interfaces such as, for example, a telephone modem, a wireless access point adhering to one or more protocols, such as IEEE 802.11 and the so-called “Bluetooth” protocols, a network interface card, a direct cable interface such as PCI or EIO, a Universal Serial Bus card (USB), an optical port operating in the ultra-violet or infra-red range, and the like. In another embodiment, input/output interface 113 is a gateway for a local area network (LAN) or a wide area network (WAN) that couples many devices within a geographic zone, such as for example, a distributed enterprise computer network operating within one or more buildings. A communication-enabled device is a device that incorporates a communication gateway, such as input/output interface 113, having one or more communication interfaces, as described above.

Imaging device 130 is any communication-enabled device configured for rendering images and document data files onto tangible media, such as, for example, paper sheet stock. FIG. 1 shows imaging device 130 further comprising a processor 131, an input/output interface 133, a memory device 135, a page frame buffer memory 138 having a page data file 139, and a compression engine 140 that includes multiple compression ratios, such as, for example ratio “A” 141, ratio “B” 142 and ratio “C” 143. The memory device 135 is shown including a program 136 and an image file 137. Processor 131 is further shown enabled for bidirectional communication with input/output interface 133, compression engine 140, page frame buffer memory 138 and memory device 135. The skilled practitioner will recognize that in some implementations imaging device 130 includes additional components not relevant to the present discussion.

Processor 131 of imaging device 110 is any microprocessor, microcontroller, application-specific integrated circuit (ASIC), or combination of the recited components, configured to execute computer instructions. In an embodiment, processor 131 includes memory for caching data. Memory device 135 includes volatile and/or non-volatile computer readable memory, such as random access memory (RAM), flash memory, and the like. In an embodiment, processor 131 is configured to execute instructions from one or more programs and services, such as program 136 stored in memory 135, and to manipulate digital data, such as image data 137.

Program 136 includes one or more computer executable instruction sets, such as device drivers and programs that perform various functions, such as managing image data and image compression functions, and directing rendering and printing functions, and generating graphical element tags. In another embodiment, program 136 is a region of interest detection program that facilitates region of interest compression for graphical elements within selected regions of a page. In still another embodiment, program 136 is an image file reading program that receives page metadata and reads various layers and region codes within a page description file to provide variable region of interest compression within selected regions of a page.

Compression engine 140 is any combination of hardware devices and software configured to provide image data compression processes within imaging device 130. In one embodiment, compression engine 140 includes a compression algorithm adhering to a standard such as, for example, the JPEG and/or JPEG 2000 standards. In other embodiments, compression engine 140 includes lossless (i.e. linear data packing) and lossy (i.e., non-linear) compression algorithms useful for implementing a variable resolution compression of a page prior to providing a page description file 139 to a page frame buffer memory 138. In one embodiment, compression ratio “A” 141 offers a highest resolution lossless predictive coding compression algorithm. In another embodiment, compression ratio B 142 is a high-resolution lossy compression algorithm, offering a higher compression ratio than compression ratio “A” 141, but at a reduced resolution. In yet another embodiment, compression ration “C” 143 is a low-resolution lossy compression algorithm, offering a very high compression ratio, but at a much lower resolution than compression ratio “A” 141 and compression ratio “B” 142. In one embodiment, compression engine 140 is configured to compress regions of a page with different compression algorithms defending on region of interest graphical element tags included in an image file 137 composed in a page description language. In another embodiment, image file 137 is provided by a computing device 110 after a region of interest is identified and graphical element tags are included in an image description.

Page frame buffer memory 138 is any hardware and/or software device for storing and/or caching image data to be printed to a tangible medium. In one embodiment, page frame buffer memory 138 includes a page data 139 representing a page. In another embodiment, the page data 139 represents a page having one or more compressed regions, where the compression resolution of each region of the page is based on one or more graphical element tags that define regions of interest. Other page frame buffer memory configurations will be recognized by the skilled practitioner to provide equivalent function and operation.

Input/output interface 133 is a communication gateway, such as input/output interface 113, as described above.

In a further embodiment, imaging device 130 is a multi-function printer-scanner device enabled to operate as a document copying and printing device. In other implementations, imaging device 130 is configured for stand-alone functionality to provide one or more embodiments of the present invention, such as for example, generating graphical element tags. The configuration and operation of printing devices will be known to the skilled practitioner, and therefore will not be discussed in further detail.

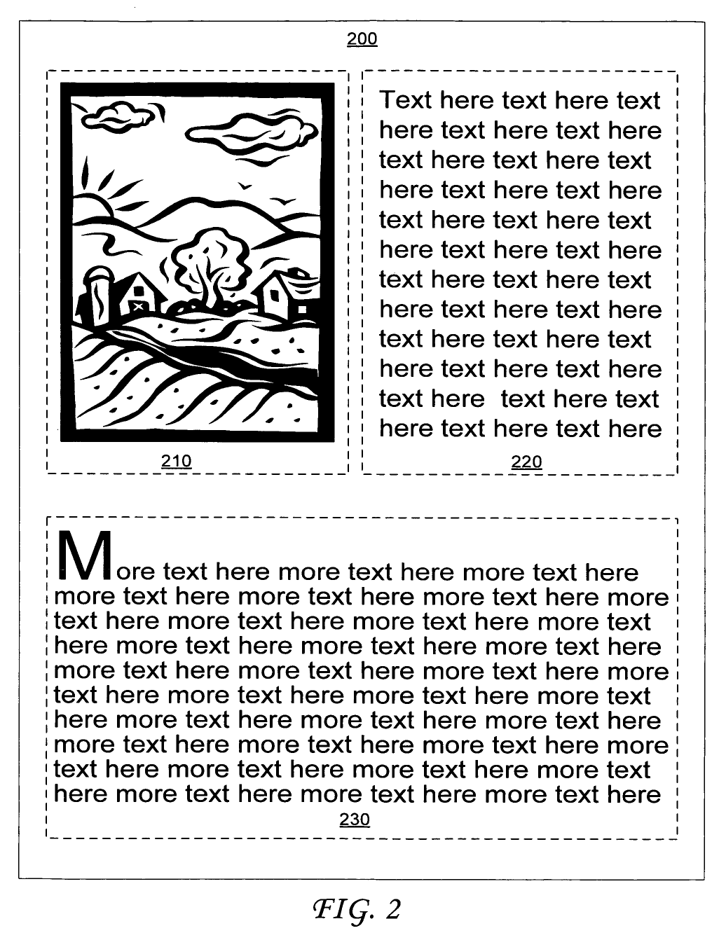

FIG. 2 illustrates an exemplary page having graphical elements and a region of interest, in accordance with an embodiment of the present invention. FIG. 2 shows a page 200 having three regions: region 210 includes an image; regions 220 and 230 include text blocks. Page 200 is any page composed in a graphical element editor program, a word processor, and the like. In one embodiment, page 200 is a letter size page. However, page 200 is merely illustrative and in other embodiments takes other forms and dimensions. Region 210, delimited with a dashed-line box, shows a clip-art-type image that has a relatively wide border. Region 220, also delimited with a dashed-line box, shows a text block. Region 230, again delimited with a dashed-line box, shows a text block having a dropped capital letter. The dashed boxes around each of the regions 210, 220 and 230 are exaggerated in scale to clearly identify the regions. In some implementations, a region of interest border is confined to the edge of any graphical elements within the region, and the graphical element shapes and dimensions define at least a portion of the region of interest.

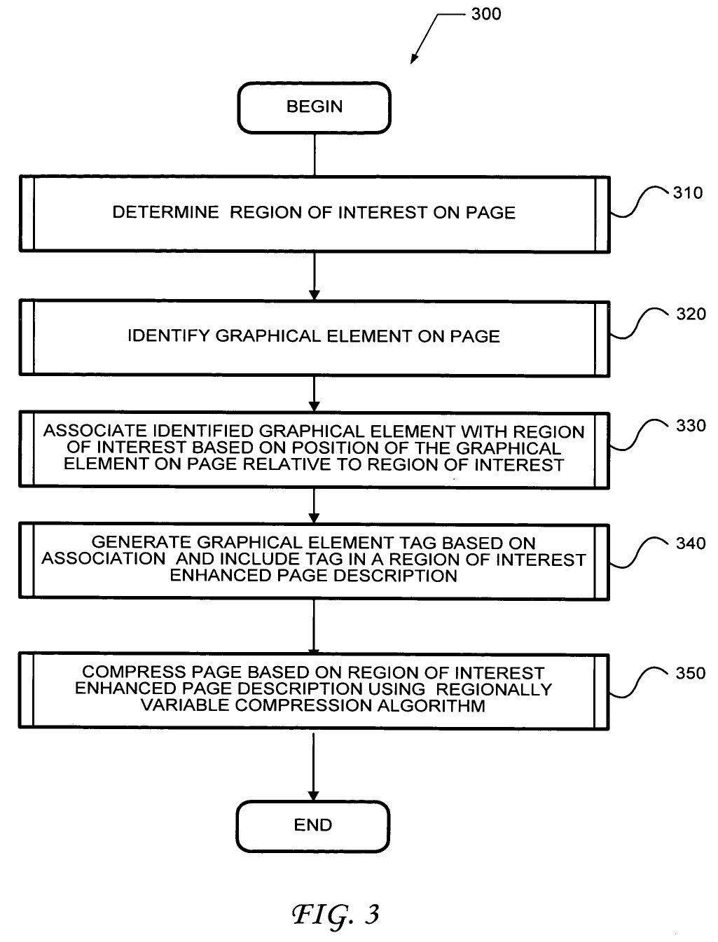

FIG. 3 is a flow diagram depicting a method, in accordance with an embodiment of the present invention. FIG. 3 illustrates a method 300 of graphical element selection for region of interest compression in a processor-controlled system. In one embodiment, method 300 is implemented with components of the exemplary system 100 of FIG. 1 and with reference to the graphical representation described in FIG. 2. In another embodiment, one or more steps of method 300 are embodied in a computer readable medium containing computer readable code, such that a series of steps are implemented when the computer readable code is executed on a computing device. Various steps of the method 300 are described with respect to a computing device 110 performing the method. In some implementations, certain steps of method 300 are combined, performed simultaneously or in a different order, without deviating from the objective of method 300 or producing different results. Method 300 begins in step 310.

In step 310, a region of interest on a page 200 is determined. The region of interest is determined at any time that a computing device 110 (FIG. 1) configured to facilitate region of interest determination is operational. In an embodiment, determining the region of interest on the page 200 includes the steps of receiving user input at a user interface 112, where the user input indicates a bounded area of the page and flags the bounded area of the page as a region of interest (e.g., regions 210, 220, 230) in response to the user input. In another embodiment, the step of determining the region of interest on the page 200 includes the step of providing the page 200 to a graphical element-type recognition system (e.g., region reader 126). The graphical element-type recognition system then identifies predetermined graphical element types on the page 200. Finally, the region of interest on the page 200 is selected based on the identified predetermined graphical element-types.

In step 320 (FIG. 3), a graphical element on the page 200 is identified. The graphical element is identified at any time after the region of interest is determined. In one embodiment, identifying the graphical element on the page 200 includes the step of receiving user input from a user interface 112 (FIG. 1), where the user input selects a graphical element (e.g., contents of region 210) on the page 200.

In step 330 (FIG. 3), an identified graphical element (e.g., contents of region 210) is associated with the region of interest (e.g., 210) based on the position of the graphical element on the page 200 relative to the region of interest. The graphical element is associated at any time after the region of interest is determined. In one embodiment, the step of associating the identified graphical element with the region of interest includes the step of mapping the graphical element to the region of interest in a graphical element layer of a page description.

In step 340, a graphical element tag is generated based on the association with the region of interest. In one embodiment, the graphical element tag is included in a region of interest enhanced page description. In another embodiment, the graphical element tag is generated by a graphical element program 123 (FIG. 1). In yet another embodiment, the graphical element tag is generated by a device driver program 125.

In still another embodiment, the graphical element tag includes a weighting factor that indicates a relative importance of a selected graphical element based on a location of the graphical element relative to a region of interest. In one embodiment, the weighting factor can be applied to define a tapering resolution compression zone surrounding a region of interest (e.g., 210). Applying a weighting factor in the foregoing manner provides images (e.g., picture contents of region 210) near an inner or outer boundary of a region of interest to be resolved.

In step 350 (FIG. 3), a page is compressed based on a region of interest enhanced page description using a regionally variable compression algorithm. The page 200 is compressed at any time after a graphical element tag is generated and incorporated into a region of interest enhanced page description. In one embodiment, the page 200 is compressed by a variable resolution compression engine 140 (FIG. 1). In another embodiment, the variable compression engine includes one or more compression ratios (e.g., ratios “A” 141, “B” 142 and “C” 143) for implementing lossy and/or lossless compression of image data prior to providing the image data to a page frame buffer memory 138.

A further embodiment includes printing the page 200 compressed in step 350 (FIG. 3) to a medium. The page 200 is printed at any time after compression. In one embodiment, a page is variably compressed into a page frame buffer memory 138 (FIG. 1) prior to printing to a medium.

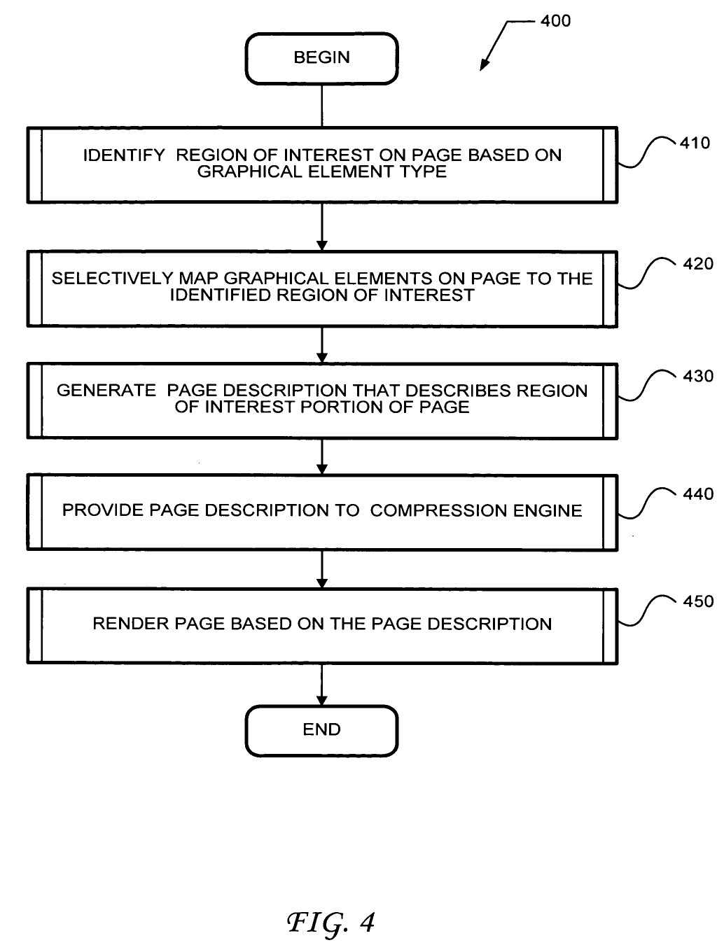

FIG. 4 is a flow diagram depicting a method, in accordance with yet another embodiment of the present invention. FIG. 4 illustrates a method 400 of selecting graphical elements on a page for variable region compression. In one embodiment, method 400 is implemented with components of the exemplary system of FIG. 1 and the graphical representations described with reference to FIG. 2. In another embodiment, one or more steps of method 400 are embodied in a computer readable medium containing computer readable code (e.g., 136) such that a series of steps are implemented when the computer readable code is executed on a computing device. Various steps of the method 400 are described with respect to a computing device performing the method. In some implementations, certain steps of method 400 are combined, performed simultaneously or in a different order, without deviating from the objective of method 400 or producing different results. Method 400 begins at step 410.

In step 410, a region of interest (e.g., region 210) on a page is identified based on a graphical element type (e.g., text, picture, and graphic content). The region of interest is identified at any time that a computing device 110 (FIG. 1) configured for region of interest identification is operational. In an embodiment, the step of identifying the region of interest (e.g., region 210) on the page 200 based on a graphical element type (e.g., picture contents of region 210) includes the steps of receiving user input to a user interface 112, selecting a graphical element on the page 200 and then generating a region of interest plane describing an area proximate to the graphical element responsive to receiving the user input. In another embodiment, a region of interest plane describes a boundary region around the selected graphical element. In yet another embodiment, identifying the region of interest on the page 200 based on the graphical element type includes the steps of providing the page to a graphical element-type recognition system, then identifying predetermined graphical element types on the page, and finally, selecting a region of interest on the page based on the predetermined graphical element types.

In step 420 (FIG. 4), one or more graphical elements on the page 200 are selectively mapped to the region of interest identified, as in step 410. The graphical elements on the page 200 are mapped at any time after a region of interest is identified, as in step 410. In one embodiment, the step of selectively mapping one or more graphical elements on the page to the identified region of interest includes the steps of first comparing a graphical element plane with a region of interest plane, then determining when at least a first graphical element of the graphical element plane overlaps with a first region of interest of the region of interest plane. Finally, the first graphical element is linked to the first region of interest.

In step 430, a page description is generated that describes a region of interest (e.g., region 210) portion of a page 200. In one embodiment, the page description relates one or more selectively mapped graphical elements (e.g., picture contents of region 210) to the region of interest. In another embodiment, the page description comprises metadata in a page description language such as, for example, PostScript, PCL and pdf.

In step 440, a page description is provided to a compression engine 140. The page description is provided at any time after the description is generated. In one embodiment, the provided page description invokes a high resolution compression process for the region of interest portion of the page (e.g., region 210). Another embodiment includes providing the page description to a compression engine such that the page description invokes a low resolution compression process for a region of the page 200 that is not a part of a region of interest (e.g., region 220).

In step 450, the page is rendered based on the page description. In one embodiment, the page is rendered at any time after the page is compressed, as in step 440.

Another embodiment further includes printing the rendered page to a media. The page is printed at any time after the page is rendered. In some embodiments, the media is a material such as, for example, paper sheet stock, transparency material, photographic paper stock and the like.

The following scenario provides an example of graphical element selection for region of interest compression. In an exemplary operating environment, a computing device 110 and a printer 160 are components of a system 100 (FIG. 1). Services are installed at the end-user (e.g., computing device 110) and at the printer 160 to manage graphical element selection for region of interest compression. A printer driver is deployed on the computing device 110 (e.g., program 125), and various client-side applications are deployed on the computing device 110 (e.g., program 123). A client side application, such as a word processor or graphical element editor program, is deployed on computing device 110 (e.g., program 123). A user accesses the word processor or graphical element editor program through a user interface 112 to select one or more regions of interest (e.g., region 210) on a page 200 (e.g., within a graphical element editor). Any graphical elements within the region of interest are then identified and associated with the region of interest based on the position of the graphical elements relative to the region of interest. One or more graphical element tags are then generated by the graphical element editor program (123) or a driver (125) which is then included in a region of interest enhanced page description. The enhanced page description is then sent to a printer where a compression engine 140 applies varying resolution compression to the page based on the graphical element tags embedded in the enhanced page description. In one implementation of the above, a region reader program is applied to automatically determine a region of interest based on various graphical element types. For example, a user composing a page with a graphical element editor program pastes in a clip art image. The clip art image is a specific graphical element type that is identified by the region reader 126, and the page area of the clip art is designated by the region reader as an area of interest. In the above manner, the region of a page having an image on a page is tagged in a page description file so that the region is compressed with a higher resolution than a non-region of interest area of the same page.

In another example, the exemplary system above (100) includes a printer 160 configured for automatic variable region of interest compression. A user composes a page with two paragraphs of text in text blocks (220, 230), a scenic picture 210, and a border. The user next invokes a print-job with a request though the user-interface 112 of the computer 110 to send the page to the printer 160 for printing. A program 136 loaded to the memory 135 of printer 160 is configured to perform steps as in method 400 in order to implement region of interest selection and variable region of interest compression on the page. The print job is received at the printer 160 as a page description in a page description language. First, the program 136 executes steps to identify the text and picture elements in the page description to select one or more regions of interest based on the graphical element type that is identified. In one example, program 136 is configured to process the received page description to identify the graphical element type and location of each element on the page and to then group elements types in close proximity into a region of interest. Next, the program 136 maps the paragraphs of text and the image in the page description to regions of interest for each element, with the picture tagged as a high priority region of interest and the text blocks tagged as lower priority regions. A modified page description is generated that includes a region of interest layer that describes the priority of each identified region of interest and the new page description is provided to a compression engine. The new page description is variably compressed with the region containing the picture retaining the greatest resolution in the compression process. The page is then rendered and printed to paper stock. The above described automated region of interest selection process reduces memory overhead in printer 160, yet provides the variable compression function transparently to a user.

Frequently, large portions of a page composed with a word processing program contain blank areas or textual blocks that do not require as much compression resolution as a picture. In another example, a boundary region around a clip art image on a page is tagged in a region of interest plane with a weighting factor so that the region is compressed with a tapering resolution expanding out from an absolute boundary edge of the image. In the above manner, the image integrity of a picture and the also the bordering region of the picture are preserved during compression, which benefits images having special effects such as edge feathering and the like. After compression, a page is provided to a page frame buffer and then the page is printed to a tangible medium such as printer paper stock.

In yet another scenario utilizing the same exemplary operating environment, a program such as a graphical element editor program/word processor (123) or region reader (126) is applied to a page to identify regions of interest (e.g., region 210) on the page 200 based on various graphical element types. A program (e.g., 123) then maps one or more graphical elements on the page to the identified regions of interest. The same program or a different program, such as a driver 125, then generates a page description for the page that describes the regions of interest and which includes in the page description various mapping data that relates the graphical elements to the regions of interest. For example, in a default mode of a graphical element editor program, a picture and a text block having a dropped capital are both identified as graphical element-types that should receive high resolution compression. The graphical element editor program identifies a first region 210 of a page 200 (FIG. 2) around a picture to be a region of interest and a second region 230 of a page around a text block having a dropped capital, and then maps any graphical elements within the region of interest to a page description layer that includes a region of interest coding. A driver program then provides the page description to a compression engine and the specially coded page description invokes high resolution compression just for the region of interest portions of the page, while other portions of the page are compressed with a lower resolution compression algorithm. The page is then rendered based on the compressed page image.

It is understood that the invention can be embodied in other specific forms not described that do not depart from its spirit or essential characteristics. The described embodiments are to be considered in all respects only as illustrative and not restrictive, the scope of the invention being defined by the appended claims and equivalents thereof.

We claim:

1. A method of graphical element selection for region of interest compression, comprising:
determining a region of interest on a page;
identifying a graphical element on the page;
associating the identified graphical element with the region of interest based on the position of the graphical element on the page relative to the region of interest;
generating a graphical element tag based on the association wherein the graphical element tag is included in a region of interest enhanced page description; and
compressing the page based on the region of interest enhanced page description using a regionally variable compression algorithm.

2. The method of claim 1, and further comprising printing the page to a medium.

3. The method of claim 1 wherein determining the region of interest on the page comprises:
receiving user input, the user input indicating a bounded area of the page; and
flagging the bounded area of the page as a region of interest responsive to receiving the user input.

4. The method of claim 1, and wherein determining the region of interest on the page comprises:
providing the page to a graphical element type recognition system;
identifying predetermined graphical element types on the page; and
selecting the region of interest on the page based on the identified predetermined graphical element types.

5. The method of claim 1, and wherein identifying the graphical element on the page comprises receiving a user input, the user input selecting the graphical element on the page.

6. The method of claim 1, and wherein the graphical element tag is included in a page description language selected from the group consisting of: PostScript, PCL and pdf.

7. The method of claim 6, and wherein the graphical element tag includes a weighting factor that indicates a relative importance of the graphical element based on a location of the graphical element relative to the determined region of interest.

8. The method of claim 1, and wherein associating the identified graphical element with the region of interest based on the position of the graphical element on the page relative to the region of interest comprises mapping the graphical element to the region of interest in a graphical element layer of a page description.

9. The method of claim 1, and wherein the graphical element tag is generated by a graphical element editor program.

10. The method of claim 1, and wherein the graphical element tag is generated by a device driver program.

11. The method of claim 1, and wherein the graphical element tag is generated by an imaging device.

12. A method of selecting graphical elements on a page for variable region compression, comprising:
identifying a region of interest on a page based on a graphical element type;
selectively mapping one or more graphical elements on the page to the identified region of interest;
generating a page description that describes the region of interest portion of the page and wherein the page description relates the one or more selectively mapped graphical elements to the region of interest;
providing the page description to a compression engine wherein the page description invokes high resolution compression for the region of interest portion of the page;and
rendering the page based on the page description.

13. The method of claim 12,, and wherein identifying the region of interest on the page based on a graphical element type comprises:
receiving user input selecting the graphical element on the page; and
generating a region of interest plane describing an area proximate to the graphical element responsive to receiving the user input.

14. The method of claim 13, and wherein the region of interest plane describes a boundary region of the selected graphical element.

15. The method of claim 12, and wherein identifying the region of interest on the page based on the graphical element type comprises:
providing the page to a graphical element type recognition system;
identifying predetermined graphical element types on the page; and
selecting a region of interest on the page based on the identified predetermined graphical element types.

16. The method of claim 12, and wherein selectively mapping one or more graphical elements on the page to the identified region of interest comprises:
comparing a graphical element plane with a region of interest plane; and
determining when at least a first graphical element of the graphical element plane overlaps with at least a first region of interest of the region of interest plane; and
linking the first graphical element to the first region of interest.

17. The method of claim 12, and wherein the page description comprises metadata in a page description language selected from the group consisting of: PostScript, PCL and pdf.

18. The method of claim 12, and further comprising providing the page description to a compression engine wherein the page description invokes low resolution compression for a page region that is not a part of the region of interest portion of the page.

19. The method of claim 12, and further comprising printing the rendered page to a media.

20. A computer readable medium storing a computer program to implement graphical element selection for region of interest compression, the program comprising:
computer readable code to determine a region of interest on a page;
computer readable code to identify a graphical element on the page;
computer readable code to associate the identified graphical element with the region of interest based on a position of the graphical element on the page relative to the region of interest;
computer readable code to generate a graphical element tag based on the association wherein the graphical element tag is included in a region of interest enhanced page description; and
computer readable code to compress the page based on the region of interest enhanced page description using a regionally variable compression algorithm.

21. The computer readable medium of claim 20, and further comprising computer readable code to cause the page to be printed to a medium.

22. The computer readable medium of claim 20, and wherein computer readable code to determine the region of interest on the page comprises:
computer readable code to direct the reception of user input, the user input indicating a bounded area of the page; and
computer readable code to flag the bounded area as the region of interest responsive to receiving the user input.

23. The computer readable medium of claim 20, and wherein computer readable code to determine the region of interest on the page comprises:
computer readable code to provide the page to a graphical element type recognition system;
computer readable code to identify predetermined graphical element types on the page;and computer readable code to select the region of interest on the page based on the identified predetermined graphical element types.

24. The computer readable medium of claim 20, and wherein computer readable code to identify the graphical element on the page comprises computer readable code to direct the reception of a user input selecting a page graphical element.

25. The computer readable medium of claim 20, and wherein computer readable code to associate the identified graphical element with the region of interest based on the position of the graphical element on the page relative to the region of interest comprises computer readable code to map the graphical element to the region of interest in a graphical element layer of a page description.

26. A computer readable medium storing a computer program to method of selecting graphical elements on a for variable region compression, comprising:
computer readable code to identify a region of interest on a page based on a graphical element type;
computer readable code to selectively map one or more graphical elements on the page to the identified region of interest;
computer readable code to generate a page description that describes the region of interest portion of the page and wherein the page description relates the one or more selectively mapped graphical elements to the region of interest;
computer readable code to provide the page description to a compression engine wherein the page description invokes high resolution compression for the region of interest portion of the page; and
computer readable code to render the page based on the page description.

27. The computer readable medium of claim 26, and wherein computer readable code to identify the region of interest on the page based on a graphical element type comprises:
computer readable code to direct the reception of user input, the user input selecting the graphical element on the page; and
computer readable code to generate a region of interest plane describing an area proximate to the graphical element responsive to receiving the user input.

28. The computer readable medium of claim 26, and wherein computer readable code to identify the region of interest on the page based on a graphical element type comprises:
computer readable code to provide the page to a graphical element type recognition system;
computer readable code to identify predetermined graphical element types on the page; and
computer readable code to select the region of interest on the page based on the identified predetermined graphical element types.

29. The computer readable medium of claim 26 wherein computer readable code to selectively map one or more graphical elements on the page to the identified region of interest comprises:
computer readable code to compare a graphical element plane with a region of interest plane; and
computer readable code to determine when at least a first graphical element of the graphical element plane overlaps with at least a first region of interest of the region of interest plane; and
computer readable code to link the first graphical element to the first region of interest.

30. The computer readable medium of claim 26, and further comprising computer readable code to cause the page to be printed to a medium.

31. A system for implementing graphical element selection for region of interest compression comprising:
imaging means, the imaging means including compression means, the compression means operable to provide variable resolution compression to selected regions of a page; and
computing means, the computing means including;
user interface means,
communication interface means,
processing means, and,
computer readable memory means which is readable by the processing means, the computer readable memory means containing a graphical element editor program, a driver program and a series of computer executable steps configured to cause the processing means to;
determine a region of interest on the page;
identify a graphical element on the page;
associate the identified graphical element with the region of interest based on a position of the graphical element on the page relative to the region of interest;
generate a graphical element tag based on the association wherein the graphical element tag is included in a region of interest enhanced page description; and
compress the page based on the region of interest enhanced page description using a regionally variable compression algorithm.

32. The system of claim 31, and wherein the series of computer executable steps configured to cause the processing means to determine the region of interest on the page comprise a series of computer executable steps configured to cause the processing means to:
receive user input, the user input indicating a bounded area of the page; and
flag the bounded area of the page as a region of interest responsive to receiving the user input.

33. The system of claim 31, and wherein the series of computer executable steps configured to cause the processing means to determine the region of interest on the page comprise a series of computer executable steps configured to cause the processing means to:
provide a page to a graphical element type recognition system;
identify predetermined graphical element types on the page; and
select a region of interest on the page based on the identified predetermined graphical element types.

34. The system of claim 31, and wherein the series of computer executable steps configured to cause the processing means to identify the graphical element on the page comprise a series of computer executable steps configured to cause the processing means to direct the reception of a user input, the user input selecting the graphical element on the page.

35. The system of claim 31, and wherein the series of computer executable steps configured to cause the processing means to associate the identified graphical element with the region of interest based on the position of the graphical element on the page relative to the region of interest comprise a series of computer executable steps configured to cause the processing means to map the graphical element to the region of interest in a graphical element layer of a page description.

36. The system of claim 31, and wherein the graphical element editor program generates the graphical element tag.

37. The system of claim 31, and wherein the device driver program generates the graphical element tag.

38. The system of claim 31, and wherein the imaging means includes the computing means, and wherein the computer readable memory means includes computer readable code to generate the graphical element tag within the imaging means.
